(19) United States
(12) Patent Application Publication
(10) Pub. No.: US 2019/0222587 A1
(43) Pub. Date: Jul. 18, 2019

(54) SYSTEM AND METHOD FOR DETECTION OF ATTACKS IN A COMPUTER NETWORK USING DECEPTION ELEMENTS

(71) Applicant: GamaSec Ltd, Herzliya Pituah (IL)

(72) Inventors: Ziv KAMIR, Herzliya Pitush (IL); Lior Rachmani, Herzliya Pitush (IL)

(73) Assignee: GamaSec Ltd, Herzliya Pituah (IL)

(21) Appl. No.: 15/871,157

(22) Filed: Jan. 15, 2018

(51) Int. Cl. H04L 29/06

(52) U.S. Cl. CPC H04L 63/1416; H04L 63/1491; H04L 63/1433

(57) ABSTRACT

Systems and methods of detecting attacks in a computer network with a processor and at least one web server may include generating at least one deception element configured to detect a malicious interaction, wherein the at least one deception element includes at least one hidden link to a web object, embedding the at least one deception element into the at least one web server, determining occurrence an attack on the at least one web server based on an indication from at least one web object linked to the at least one deception element, and issuing an alert upon detection of an attack attempt, wherein the web object is selected from the group consisting of web pages, web forms and search forms.

### FIELD OF THE INVENTION

The present invention relates to data security in computer networks. More particularly, the present invention relates to systems and methods for detection and/or prevention of attacks in a computer network.

### BACKGROUND OF THE INVENTION

Service providers such as companies and/or organizations that offer publicly accessible servers in their computer network, for instance via accessible websites, are constantly vulnerable to attacks through the interface that they offer. Such vulnerabilities may provide the potential for an unauthorized party to gain access to critical and/or sensitive information, use resources inappropriately and/or commit fraud. For example, a malicious hacker may use an automated vulnerability scan for the website of a public transportation company and initiate a denial of service (DoS) attack by flooding a particular webpage at the website of the company with more traffic than it was designed to handle.

Automated web vulnerability scanners may operate without the awareness of the owner of the server, and may conduct various operations to perform a web vulnerability assessment. For example, a scan may start with a target web address (or URL) provided by the user or client, where the vulnerability scanner identifies all URLs, forms and query string parameters in the website by crawling and mapping the website. Upon completion of the mapping, the vulnerability scanner may enter designated strings to dedicated fields of each parameter in order to trigger flaws in the webserver.

Usually, the communication between various clients and publicly accessible servers takes place using the hypertext transfer protocol (HTTP), where pages can be delivered as hypertext markup language (HTML) documents, including images, style sheets and scripts in addition to text content. Some web servers also support server-side scripting using active server pages (ASP), hypertext preprocessor (PHP), or other scripting languages, so that the behavior of the web server may be scripted in separate files, for example to generate HTML documents dynamically (“on-the-fly”) as opposed to returning static documents. Automated web vulnerability scanners may scan and map such documents and/or scripts.

### SUMMARY OF THE INVENTION

There is thus provided, in accordance with some embodiments of the invention, a method of detecting attacks in a computer network, the network including a processor and at least one web server, the method including: generating, with the processor, at least one deception element configured to detect a malicious interaction, wherein the at least one deception element includes at least one hidden link to a web object, embedding, with the processor, the at least one deception element into the at least one web server, determining, with the processor, occurrence of an attack on the at least one web server based on an indication from at least one web object linked to the at least one deception element, and issuing an alert upon detection of an attack attempt. In some embodiments, the web object may be selected from the group consisting of web page, web forms and search forms.

In some embodiments, the blocking of the detected attack attempt may be triggered. In some embodiments, the at least one deception element may be embedded into at least one web object at the at least one web server. The at least one deception element may be, in some embodiments, modified in accordance with at least one of a predefined time period and activation of the at least one web object. In some embodiments, the at least one deception element may be modified for at least one of the web link name, the link content, the web form input fields, and the web form action pointing file name.

In some embodiments, the malicious interaction may include at least one of attack and automated web application vulnerability scanning In some embodiments, the at least one hidden web link activated by an attack attempt may be linked to a predefined web object of the at least one web server, the predefined web object including a hidden tag. In some embodiments, the hidden tag may link the attack attempt to a predefined form action file of the at least one web server. In some embodiments, at least one of “Form's parameters”, “unique server ID”, “attack IP address”, “server IP Address”, “script name”, “user agent”, “referrer header” and “cookie header” may be recorded (for example recorded in a database by the processor) upon detection of an attack attempt.

In some embodiments, the origin of the attack attempt may be determined based on an analysis of the recorded data. In some embodiments, the at least one deception element may be embedded into the at least one web server based on a predefined rule, where the predefined rule may be at least one of time dependent and randomly selected. In some embodiments, a predefined false positive response may be sent to a query of the attack attempt. In some embodiments, the at least one hidden web link may be linked to at least one file including the hidden web form. In some embodiments, the content of at least one of: at least one deception element and at least one hidden link to a web object with input from a decoy database in communication with the at least one web server may be modified.

There is thus provided, in accordance with some embodiments of the invention, a system for detection of attacks in a computer network, the system including: at least one web server, and at least one processor, coupled to the at least one web server, wherein the at least one processor is configured to: generate at least one deception element configured to detect a malicious interaction, wherein the at least one deception element includes at least one hidden link to a web object, embed the at least one deception element into the at least one web server, determine occurrence of an attack on the at least one web server based on an indication from at least one web object linked to the at least one deception element, and issue an alert upon detection of an attack attempt.

In some embodiments, the system may further include a communication module configured to allow communication between the at least one web server and the at least one processor. In some embodiments, the system may further include a decoy database in communication with the at least one web server, wherein the at least one processor is configured to modify content of at least one of: at least one deception element and at least one hidden link to a web object with input from the decoy database.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device, according to some embodiments of the invention;

FIGS. 2A-2B show block diagrams of a system for detection of attacks in a computer network, according to some embodiments of the invention; and

FIG. 3 shows a flowchart for a method of detecting attacks in a computer network, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

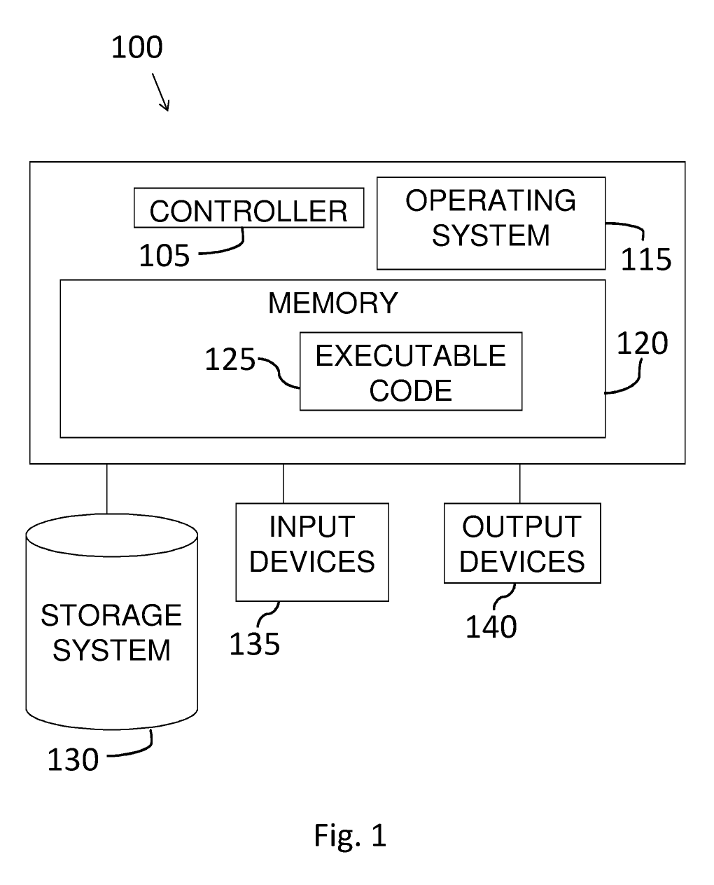

Reference is made to FIG. 1, which shows a block diagram of an exemplary computing device, according to some embodiments of the invention. A device 100 may include a controller 105 that may be, for example, a central processing unit processor (CPU), a chip or any suitable computing or computational device, an operating system 115, a memory 120, executable code 125, a storage system 130 that may include input devices 135 and output devices 140. Controller 105 (or one or more controllers or processors, possibly across multiple units or devices) may be configured to carry out methods described herein, and/or to execute or act as the various modules, units, etc. More than one computing device 100 may be included in, and one or more computing devices 100 may act as the components of, a system according to embodiments of the invention.

Operating system 115 may be or may include any code segment (e.g., one similar to executable code 125 described herein) designed and/or configured to perform tasks involving coordination, scheduling, arbitration, supervising, controlling or otherwise managing operation of computing device 100, for example, scheduling execution of software programs or tasks or enabling software programs or other modules or units to communicate. Operating system 115 may be a commercial operating system. It will be noted that an operating system 115 may be an optional component, e.g., in some embodiments, a system may include a computing device that does not require or include an operating system 115.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. Although, for the sake of clarity, a single item of executable code 125 is shown in FIG. 1, a system according to some embodiments of the invention may include a plurality of executable code segments similar to executable code 125 that may be loaded into memory 120 and cause controller 105 to carry out methods described herein.

Storage system 130 may be or may include, for example, a flash memory, a hard disk drive, a universal serial bus (USB) device or other suitable removable and/or fixed storage unit. Content may be stored in storage system 130 and may be loaded from storage system 130 into memory 120 where it may be processed by controller 105. In some embodiments, some of the components shown in FIG. 1 may be omitted. For example, memory 120 may be a non-volatile memory having the storage capacity of storage system 130. Accordingly, although shown as a separate component, storage system 130 may be embedded and/or included in memory 120.

Input devices 135 may be or may include any suitable input devices, components or systems, e.g., a detachable keyboard or keypad, touchscreen, a mouse and the like. Output devices 140 may include one or more (possibly detachable) displays or monitors, speakers and/or any other suitable output devices. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140. It will be recognized that any suitable number of input devices 135 and output device 140 may be operatively connected to computing device 100 as shown by blocks 135 and 140. For example, input devices 135 and output devices 140 may be used by a technician or engineer in order to connect to a computing device 100, update software and the like.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a controller such as controller 105.

The storage medium may include, but is not limited to, any type of disk including magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

Some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a Personal Digital Assistant (PDA) device, a tablet computer, a network device, or any other suitable computing device.

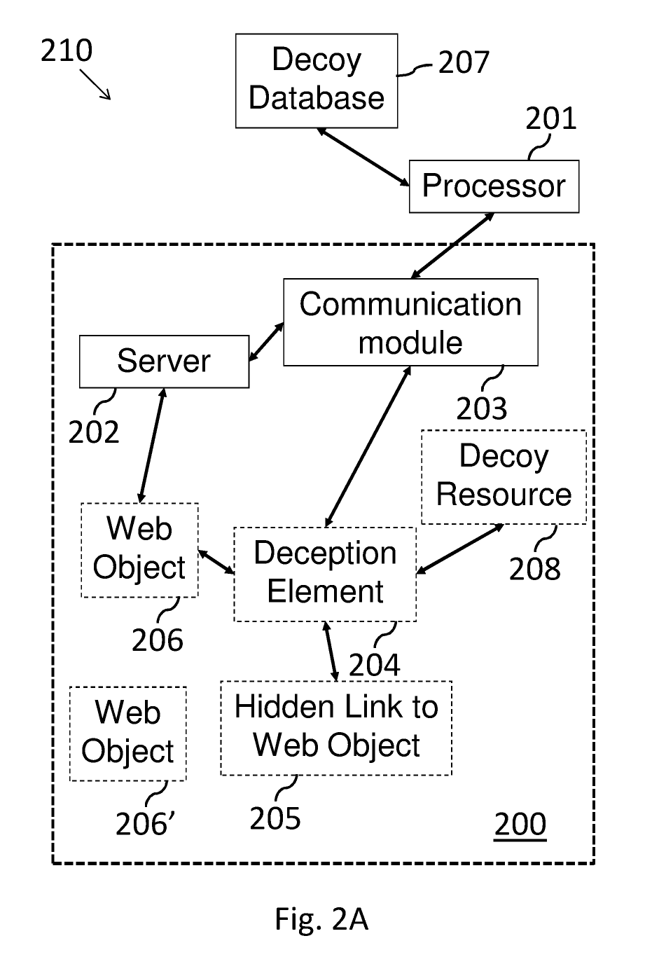

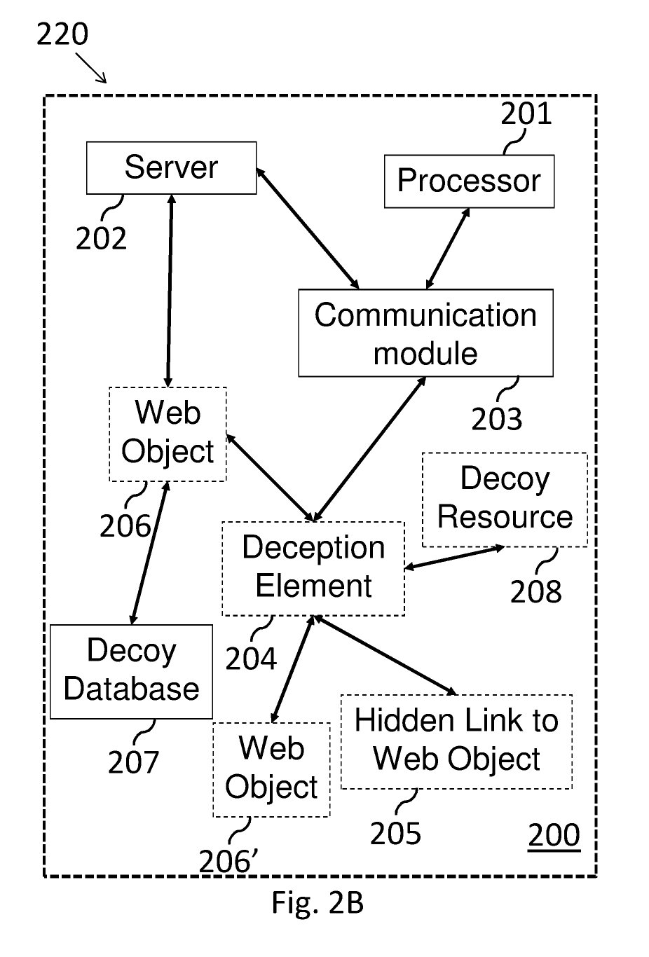

Reference is made to FIGS. 2A-2B, which show block diagrams of systems for detection (e.g. automatic detection) of attacks in a computer network, according to some embodiments of the invention. The direction of arrows in FIGS. 2A-2B may indicate the direction of information flow in some embodiments.

FIG. 2A shows a block diagram of a system 210 for detection of attacks in a computer network 200. According to some embodiments, the system 210 may include at least one processor 201 (e.g., such as a computerized device or controller in FIG. 1) in communication with at least one web server 202 (e.g., such as a computerized device or controller in FIG. 1) of computer network 200. In some embodiments, communication between processor 201 and elements of computer network 200 (such as web server 202) may be carried out via a communication module 203, for instance allowing communication via internet protocol. According to some embodiments, processor 201 may be included in network 200 as system 220 for detection of attacks in a computer network 200 shown for example in FIG. 2B. Various modules and devices of FIG. 2, e.g., server 202, processor 201, decoy database 207, etc., may be or include components of FIG. 1.

The at least one web server 202 may provide various services to users external to computer network 200, wherein the service may be provided to users communicating with at least one web server 202 via a web connection and/or via communication module 203. For example, the web server 202 may allow external users to access a web site and/or database of computer network 200 (e.g., in the case of a commercial company having a public web site).

According to some embodiments, processor 201 may carry out or execute an algorithm to generate and/or embed at least one deception element 204 in web server 202 in order to detect and/or block malicious interactions or attacks on web server 202. In some embodiments, at least one deception element 204 may be embedded or added into the at least one web server 202 (by, for example adding a hidden link to objects stored on or operated by the server, e.g. by adding or embedding a link to a web page executed by or supported by the server) based on a predefined rule, wherein the predefined rule is at least one of time dependent and randomly selected. For example, at least one deception element 204 such as hidden link and/or form may be added to the source code of a webpage (e.g., before the footer of the code) using a ‘div’ tag with the style “Display: none” which completely removes an element from the display page where the surrounding elements will treat the element as empty space and adapt accordingly. In another example, the embedded hidden HTML link may point to a webpage (e.g., “SiteMapOld.aspx”), by using the style “display:none” where the webpage content is hidden and not shown on the webpage, and the webpage's content may be pulled from a remote server. Deception element 204 may be for example a software process executed by a processor, for example a processor in web server 202, the software process configured (e.g., automatically) in accordance with the operating system running on the corresponding web server 202.

In some embodiments, the at least one deception element 204 may include at least one hidden link 205 (e.g., a hyperlink or URL) to a web object 206 (e.g., a web page, web forms or search forms). In some embodiments, processor 201 may determine that an attack is taking place on the at least one web server 202 based on an indication from at least one web object 206 and issue an alert (e.g., to the user and/or to the web server 202) upon detection of an attack attempt. In some embodiments, web object 206 may be a non-visual object (in contrast to web pages) for general purpose servers. In some embodiments, hidden link 205 may be an object such as an image.

In some embodiments, the attack may be blocked upon such determination, for instance processor 201 may block IP addresses (e.g., of scanners) with a firewall of web server 202. In some embodiments, malicious interaction with server 202 may include at least one of attack and automated web application vulnerability scanning.

In some embodiments, at least one deception element 204 (e.g., a decoy HTML link or other software process) may be only accessible to automatic web scanners and/or application vulnerability scanners and not visible to regular users. For example, deception element 204 may be embedded or added into the code of a web page 206 (e.g., with cascading style sheets style disabling display) such that only a scanner may detect the deception element 204 while a user browsing the web page 206 will experience a change in the web site. In another example, deception element 204 may be displayed in predetermined color to be disguised and/or blend in with the background color of the web page 206, thereby nit visible to regular (non-malicious) users.

In some embodiments, automatic scanners may ignore cascading style sheets (CSS) style of web object 206 (e.g., style of a web page) so the at least one deception element 204 may point to a different web object 206′, such as a web page which is a web object 206 at web server 202, including a hidden tag with a form and/or an action that points to another form (or file) on the web server 202. Such deception element 204 may be hidden from regular users (e.g., with CSS code “display:none”) and only detected by automatic scanners. In some embodiments, hidden tags may link the attack attempt to a predefined form action file of the at least one web server 202.

In some embodiments, on each form submission e by scanners (or by a hacker) useful information may include at least one of “form's parameters”, “unique server ID”, “client IP address”, “server IP address”, “script name”, “user agent”, “referrer header” and “cookie header’ for analysis, where the analyzed information may be used to identify the malicious party. For example, such useful information may be recorded (e.g., in a database by processor 201) upon detection of an attack attempt.

In some embodiments, at least one parameter (e.g., a web link name, content of a link, web form input fields, etc.) of each deception element 204 may be modified (e.g., randomly modified by processor 201) after a predefined time period and/or in accordance with a determined type of attack/scan and/or activation of the at least one web object. For example, a malicious scan may interact with the deception element and open a link such that the corresponding web object 206 may be activated. In some embodiments, modification of the at least one deception element 204 may prevent scanners from identifying the pattern of the deception element 204 and thereby ignoring them.

For example, the web object 206 (e.g., a web page at “index.html”) may include hidden links 205 pointing to web pages 206 with a hidden tag and/or form with an action that points to another file on the web server 202, such that a regular user may not observe the at least one deception element 204 while visible to attackers and/or vulnerability scanners.

According to some embodiments, at least one deception element 204 may be constant and embedded into a web object 206, where the at least one deception element 204 may point to a decoy resource 208 (e.g., via a link). In some embodiments, at least one decoy resource 208 may be embedded in the web object 206 (e.g., a web page).

According to some embodiments, at least one deception element 204 may be embedded into a web object 206 and may be changeable due to the pointer to a second web object 206 (e.g., a web page of links), where these links may point to at least one decoy resource 208. In some embodiments, only the content on the second web object 206 may be changeable with data from an external server (e.g., dedicated external server for firewall purposes). In some embodiments, the content on the second web object 206 may be generated with recursive input from a dedicated decoy resource database (e.g., rotation of ten predefined links). In some embodiments, only the content of the at least one decoy resource 208 (e.g., embedded in the web object 206) may be changeable. It should be noted that the second web object 206 may be required to be maintained on the web server 202 in order to be engaged by automatic scanners.

According to some embodiments, the content on the second web object 206 may be remotely changed by an external server (e.g., dedicated external server for firewall purposes). In some embodiments, the at least one deception element is modified with respect to the parameters such as at least one of the web link name, the link content, the web form input fields, and the web form action pointing file name, for example the name of the decoy resource 208 may be remotely modified (e.g., in PHP script). It should be appreciated that when content on the second web object 206 is remotely changed by an external server (e.g., via TCP port 9191), the content of network 200 may remain private as the remote server (e.g., maintained by an external company) only has access to change links on the second web object 206 and no access to modify data in network 200, thus maintaining privacy.

According to some embodiments, network 200 may further include a dedicated decoy database 207 (e.g., for a honeypot server) configured to modify content on the second web object 206 and/or decoy resource 208 according to predetermined rules. It should be appreciated that while such decoy database 207 may be installed and configured by an external party, after installation all data transfer with decoy database 207 may remain within network 200 to maintain privacy, for instance such that the external party does not need to login remotely to operate the decoy database 207.

In some embodiments, at least one of deception element 204 and decoy resources 208 may be configured in accordance with the structure of network 200. For example, at least one deception element 204 may be configured in accordance with the structure of a web site on server 202.

In some embodiments, deception element 204 may require input of decoy username and/or password so that if such elements are engaged an attack may be determined. In some embodiments, automatic crawlers or scanners engaging ‘submit’ option at the form file may trigger an attack alert.

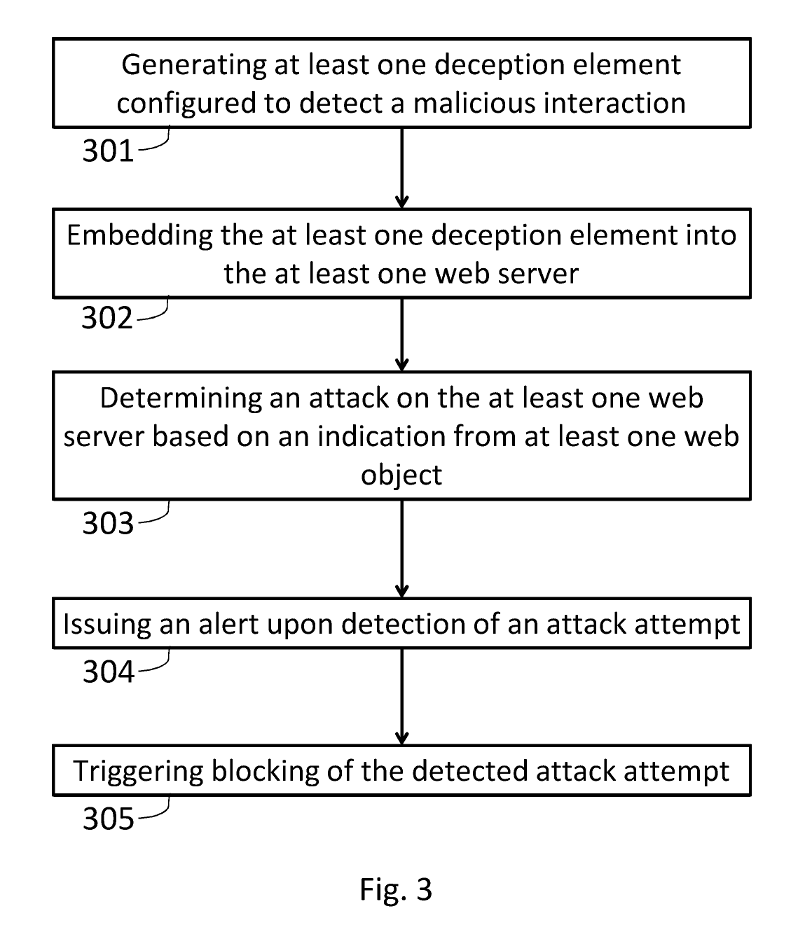

Reference is made to FIG. 3, which shows a flowchart for a method of detecting attacks in a computer network, according to some embodiments of the invention. While the flowchart refers to the physical hardware, modules, and data structures discussed in FIGS. 1, 2A and 2B, the embodiment shown in FIG. 3 may be carried out with any suitable hardware arrangement. In some embodiments, at least one deception element 204 (configured to detect a malicious interaction) may be generated 301 (e.g., generated by the processor 201). In some embodiments, the at least one deception element 204 may include at least one hidden link to a web object 206.

In some embodiments, the at least one deception element 204 may be embedded 302 into the at least one web server 202 (e.g., embedded by the processor 201). In some embodiments, occurrence of an attack on the at least one web server 202 may be determined 303 based on an indication from at least one web object 206 linked to the at least one deception element 204 (e.g., indication or alert of an interaction with the deception element 204). In some embodiments, an alert may be issued 304 upon detection 303 of an attack attempt.

In some embodiments, the origin of the attack attempt may be determined based on an analysis of recorded data, for instance recording log of activated links. In some embodiments, the log file of the at least one web server 202 may be monitored in order to determine occurrence of an attack is taking place thereon. In some embodiments, a predefined false positive response to a query of the attack attempt may be sent as a decoy.

According to some embodiments, issuing 304 of an alert upon detection 303 of an attack attempt may trigger 305 blocking (e.g., by processor 201 and/or by communication module 203) of the detected attack attempt. In some embodiments, the at least one hidden web link 205 (e.g., activated by an attack attempt) may be linked to a predefined web object 206 (e.g., with a hidden tag) of the at least one web server 202.

The abovementioned systems and methods may, in some embodiments, allow improved detection of attacks in computer networks with automatic generation of deception elements that only interact with malicious parties, thereby providing protection to computer systems from unwanted scanning and/or data theft.

Unless explicitly stated, the method embodiments described herein are not constrained to a particular order in time or chronological sequence. Additionally, some of the described method elements may be skipped, or they may be repeated, during a sequence of operations of a method.

Various embodiments have been presented. Each of these embodiments may of course include features from other embodiments presented, and embodiments not specifically described may include various features described herein.

1. A method of detecting attacks in a computer network, the network comprising a processor and at least one web server, the method comprising:
generating, with the processor, at least one deception element configured to detect a malicious interaction, wherein the at least one deception element comprises at least one hidden link to a web object;
embedding, with the processor, the at least one deception element into the at least one web server;
determining, with the processor, occurrence of an attack on the at least one web server based on an indication from at least one web object linked to the at least one deception element; and
issuing an alert upon detection of an attack attempt,
wherein the web object is selected from the group consisting of web page, web forms and search forms.

2. The method of claim 1, further comprising triggering blocking of the detected attack attempt.

3. The method of claim 1, wherein the at least one deception element is embedded into at least one web object at the at least one web server.

4. The method of claim 1, further comprising modifying the at least one deception element in accordance with at least one of a predefined time period and activation of the at least one web object.

5. The method of claim 4, wherein the at least one deception element is modified with respect to at least one of the web link name, the link content, the web form input fields, and the web form action pointing file name.

6. The method of claim 1, wherein the malicious interaction comprises at least one of attack and automated web application vulnerability scanning.

7. The method of claim 1, further comprising linking the at least one hidden web link activated by an attack attempt to a predefined web object of the at least one web server, and wherein the predefined web object comprises a hidden tag.

8. The method of claim 7, wherein the hidden tag links the attack attempt to a predefined form action file of the at least one web server.

9. The method of claim 1, further comprising recording at least one of “Form's parameters”, “unique server ID”, “attack IP address”, “server IP Address”, “script name”, “user agent”, “referrer header” and “cookie header” upon detection of an attack attempt.

10. The method of claim 9, further comprising determining origin of the attack attempt based on an analysis of the recorded data.

11. The method of claim 1, wherein the at least one deception element is embedded into the at least one web server based on a predefined rule, and wherein the predefined rule is at least one of time dependent and randomly selected.

12. The method of claim 1, further comprising sending a predefined false positive response to a query of the attack attempt.

13. The method of claim 1, wherein the at least one hidden web link is linked to at least one file comprising the hidden web form.

14. The method of claim 1, further comprising modifying content of at least one of: at least one deception element and at least one hidden link to a web object with input from a decoy database in communication with the at least one web server.

15. A system for detection of attacks in a computer network, the system comprising:
at least one web server; and
at least one processor, coupled to the at least one web server,
wherein the at least one processor is configured to:
generate at least one deception element configured to detect a malicious interaction, wherein the at least one deception element comprises at least one hidden link to a web object;
embed the at least one deception element into the at least one web server;
determine occurrence of an attack on the at least one web server based on an indication from at least one web object linked to the at least one deception element; and
issue an alert upon detection of an attack attempt.

16. The system of claim 15, further comprising a decoy database in communication with the at least one web server, wherein the at least one processor is configured to modify content of at least one of: at least one deception element and at least one hidden link to a web object with input from the decoy database.

17. A method of detecting attacks in a computer network, the method comprising:
adding, by a processor, a hidden link to a web page operated by a web server;
detecting, using the hidden link, a malicious interaction; and
determining, by the processor, occurrence of an attack on the at least one web server based on detected malicious interactions.
